(19) United States
(12) Patent Application Publication
(10) Pub. No.: US 2023/0186058 A1
(43) Pub. Date: Jun. 15, 2023

(54) HIGH-RESOLUTION IC NET ROUTING SYSTEM, COMPONENTS AND METHODS WITH DEEP NEURAL NETWORKS

(71) Applicant: THE BOARD OF TRUSTEES OF THE UNIVERSITY OF ILLINOIS, Urbana, IL (US)

(72) Inventor: Inna Partin-Vaisband, Urbana, IL (US)

(21) Appl. No.: 18/065,068

(22) Filed: Dec. 13, 2022

Related U.S. Application Data
(60) Provisional application No. 63/289,056, filed on Dec. 13, 2021.

(51) Int. Cl. G06N 3/0475

(52) U.S. Cl. CPC G06N 3/0475

(57) ABSTRACT

A multiterminal obstacle-avoiding pathfinding system that utilizes deep image learning. In accordance with the principles herein, a conditional generative adversarial network (cGAN) can be trained to interpret a pathfinding task as a graphical bitmap and consequently map a pathfinding problem onto a pathfinding solution represented by another bitmap. Due to effective parallelization on parallel processing hardware (such as GPU, TPU, NPU, or similar), the system yields over an order of magnitude speedup over traditional approaches with no wirelength overhead. The cGAN router can be exploited to significantly speed up routing and iterative placement in modem ICs.

### CROSS-REFERENCE TO RELATED APPLICATIONS

This application claims the benefit of U.S. Provisional Application No. 63/289,056 filed Dec. 13, 2021 and incorporated herein by reference in the entirety.

### TECHNICAL FIELD

The present disclosure relates to net routing. More specifically, the disclosure relates to high resolution global IC net routing, associated systems, components, and methods.

### BACKGROUND

Multiterminal net routing in presence of obstacles is a bottleneck for efficient and fast global routing in modern integrated systems. Global routing is a fundamental step of physical IC design which generates routing paths by connecting placed IC terminals within placed obstacle and specific technology limitations. Global routing is a complex combinatorial problem yet requires both precise and computationally efficient solution.

As part of global routing, thousands of multiterminal nets are connected within a multilayered routing region, partitioned into an array of rectangular tiles. The quality and runtime of global routing solution is, therefore, a strong function of the individual net routing performance. To mitigate the computational complexity of the net routing, existing routers use approximation heuristics, producing sub-optimal solutions in reasonable time. The traditional deterministic routing approaches typically exhibit the following design flow: nets are decomposed into multiple terminal-to-terminal routing problems and the terminal-to-terminal problems are solved individually.

Existing modern routers vary primarily by algorithms for net decomposition and terminal-to-terminal connection as well as algorithm convergence criteria. The primary limitation of these routers is the unpredictability of routing convergence and performance and the series nature of the underlying algorithms, making parallelization on massively parallel multi-processor hardware less practical. Several important machine learning (ML) approaches have recently been proposed to alleviate the unpredictability issue. With these approaches, ML models are utilized to predict the outcome of traditional algorithms with specific initialization. Routing parallelization is, however, still not feasible with existing approaches. A paradigm shift is, therefore, needed to allow a significant speedup of critical electronic design automation (EDA) tasks.

During the global routing phase, the overall routing region with placed terminals and obstacles is partitioned into an array of rectangular tiles. Each tile within the array is constrained by a limited capacity of routing tracks per metal layer, as determined by the physical size of the individual tiles, preferred routing track constraints, and design rules. The primary objective of a global router is determining the tile-to-tile paths for all the nets (each net connects two or more placed terminals within the overall routing region) under the limited capacity constraints.

Once all the global routing paths are determined, detailed routing algorithm is executed for determining the exact location of routing tracks within the individual tiles and metal layers and the vias location between the adjacent metal layers. A typical routed two-terminal net is illustrated in FIG. 1. The terminals that need to be connected are shown in FIG. 1A and the preferred global and detailed routing solutions are shown in, respectively, FIG. 1B and FIG. 1C. During the global routing phase, the path of the routed net is determined in terms of the routing tiles, but the exact rail and via locations are not yet determined. These locations are determined during the detailed routing phase, as shown with the lines and highlighted squares in FIG. 1C.

Global routing problem is a NP-hard problem, which is typically decomposed into a set of single-net multiterminal routing problems. Typical input to a multiterminal net routing problem is the number and location of the net terminals, information about the routing region (such as size constraints or net width), and coordinates of placed obstacles within the region. An expected output is a path of minimum wirelength that connects all terminals within routing region and have no intersections with obstacles. These single-net routing problems are also NP-hard but can be approximately decomposed and solved in polynomial time with reasonable wirelength overhead.

Traditional single-net multiterminal routing approaches are based on minimum rectilinear Steiner tree (MRST) approximation. MRST is a minimum weight tree which comprises a predetermined set of nodes connected with horizontal or vertical edges. With MRST, a multiterminal routing problem can be split into multiple terminal-to-terminal pathfinding problems, using additional auxiliary nodes (i.e., Steiner split-point nodes). Each edge in MRST represents a path between two tiles, which can be determined with two-point pathfinding algorithm in polynomial time.

Decomposition of a multiterminal routing problem into multiple terminal-to-terminal pathfinding problems is, however, also NP-hard. Thus, approximating methods such as minimal spanning tree (MST) are often utilized instead of MRST, yielding suboptimal, yet computationally preferred solutions with a typical computational complexity of 0(n . log(n)²), where n is number of routing tiles. A primary advantage of the MST method is that the total wirelength of the generated routing path is within certain bounds of the optimal wirelength. Another method for mitigating the MRST complexity is lookup tables. These methods typically exhibit polynomial time complexity, trading off the optimal wirelength for a shorter execution runtime.

Once the original multiterminal routing problem is successfully split into multiple two-terminal sub-problems, best-first search algorithms are commonly utilized for determining paths between the original net terminal and split-point nodes, as well as paths between different split-points of the Steiner tree. Hard-to-route nets that prevent routing convergence are attempted multiple times with rip-up and reroute algorithms. Methods such as pattern routing, negotiated-congestion routing, and integer linear programming (ILP) are utilized in modern global routers to speed those easy-to-route nets up and resolve difficult-to-route regions. An optimal MRST and sub-optimal MST routing is illustrated in FIG. 2.

The primary limitation of existing approaches is that both the splitting of the multiterminal routing problem and the two-terminal routing are optimized for the traditional single instruction single data (SISD) or multiple instruction multiple data (MIMD) CPU architectures and are not naturally GPU parallelizable. The reason is that the best-first search algorithms are based on grid traversal with certain heuristics, typically yielding non-regular computational methods. Efficiently parallelizing these traditional solutions for single instruction multiple data (SIMD) GPU architecture is, therefore, challenging and cost inefficient.

Alternatively, modern ML image processing solutions are reduced to convolution operations (e.g., within a convolutional kernel or convolutional layers of deep neural networks), that are decomposed into a large number of small independent matrix multiplications. GPU hardware can, therefore, be efficiently utilized in this type of computation with large number of cores and parallel access to local and shared memory. Thus, mapping a routed layout onto a 2D image transforms an inherently sequential problem to a naturally parallelizable one, enabling efficient utilization of GPU platforms. Identifying an appropriate class of imaging problems and effectively representing routing problems within that class is, therefore, a primary objective. Yet another objective is to design a large training dataset of optimally routed layouts, as required in typical ML imaging solutions.

At the core of the existing global routing solutions is, however, the reliance on grid traversing and similar algorithms that yield non-regular and, thus, poorly parallelizable computational methods. While neural networks typically utilize highly parallelizable topologies (i.e., a single instruction can simultaneously be performed with multiple data points on multiple processing units), existing routers are series in their nature and their runtime cannot be efficiently shortened through parallelization (i.e., instructions are highly interdependent and should be executed in order). Such routing (or pathfinding) with poorly scalable traditional methods becomes even more challenging with the increasing number of terminals and obstacles in modern integrated circuits (ICs).

What is needed is an efficient solution to generating routes in a constrained 2D space including routing time that does not increase with increasing routing resolution, number of endpoints, and number of obstacles.

### SUMMARY

In accordance with the principles herein, a multiterminal obstacle-avoiding pathfinding system can comprise a net generator in a bitmap format comprising a trainable conditional generative adversarial network (cGAN) configured to generate a cGAN routing architecture solution to connect all the terminals and to generate complex, obstacle-avoiding multiterminal net while minimizing wirelength of the routed net. The system can comprise a trainable cGAN operably connected to a processor comprising executable software configured to generate an image-to-image mapping for the cGAN routing architecture solution. The system can further comprise a parallel computing hardware (including but not limited to graphical processing units (GPU), tensor processing units (TPU), neural processing units (NPU)) operably connected to the processor. In addition, the system can further comprise synthetic or commercially available routed training samples for training the cGAN generator, operably connected to the processor of the system.

In another embodiment, a multiterminal obstacle-avoiding pathfinding system can comprise: a trainable conditional generative adversarial network (cGAN) operably connected to a processor, the cGAN trained to interpret a pathfinding task as a graphical bitmap and to map a pathfinding problem onto a pathfinding solution represented by another bitmap of the system. The system can further comprise a dynamic, synthetically generated or commercially available dataset (example in application) operably connected to the processor. The system can be configured to enable effective parallelization on parallel computing hardware, wherein the system yields over an order of magnitude speedup over traditional approaches with no wirelength overhead.

The system can further comprise a post-processing component configured to merge clustered nets generated by cGAN. The post-processing component can be further defined by a median filter for image noise reduction of an invalid net, and a cluster merging instruction set connecting the net clusters, the median filter and cluster merging instruction set operably connected to the system via the processor. The cluster merging instruction set can be configured to identify pairs of closest endpoints from two different clusters for all disconnect endpoints based on Manhattan distance, and to merge two clusters, the identified closest terminal endpoints are connected with a maze-routing instruction set.

The system can further comprise one or more components to connect all the terminals in the pathfinding solution. The system can further comprise at least two deep neural networks. The system can further comprise a submodel generator conditioned by an input comprising placed terminals and obstacles.

A multiterminal obstacle-avoiding pathfinding routing system according to the principles herein can comprise a custom loss function having instructions configured to penalize a routing model if a number of tiles, nₜ, included by the model within a routing path is different from a number of tiles in a reference routing path, nₜ,_{ref′} wherein penalties for nₜ exceeding and falling short of nₜ,_{ref} differ. Other embodiments constructed in accordance with the principles herein are contemplated as well.

The attributes and advantages will be further understood and appreciated with reference to the accompanying drawings. The described embodiments are to be considered in all respects only as illustrative and not restrictive, and the scope is not limited to the foregoing description. Those of skill in the art will recognize changes, substitutions and other modifications that will nonetheless come within the scope and range of the claims.

### BRIEF DESCRIPTION OF DRAWINGS

The preferred embodiments are described in conjunction with the attached figures.

FIG. 1A illustrates a block diagram of a partitioned circuit with two terminals, T1 and T2, that require connection.

FIG. 1B illustrates a block diagram of the partitioned circuit with global routing of the two terminals, T1 and T2, that require connection.

FIG. 1C illustrates a block diagram of the global routing of a preferred pathfinding solution to connecting the two terminals, T1 and T2, of FIG. 1A.

FIG. 2A illustrates routing a four-terminal net with the optimal terminal-to-split point routing as determined by the MRST approach, resulting in the shortest total wirelength.

FIG. 2B illustrates routing a four-terminal net with terminal-to-terminal routing as determined by the MST approximation.

FIG. 3A illustrates neural network (NN) hyperparameters with a convolutional kernel reducing the bitmap dimension.

FIG. 3B illustrates NN hyperparameters with dimensionality reduced with max-pooling.

FIG. 3C illustrates NN hyperparameters with bitmap dimensionality maintained with intermediate zero padding.

FIG. 4 illustrates a block diagram of training a cGAN to generate optimal multiterminal nets.

FIG. 5A illustrates a block diagram of a set of low-resolution optimally routed bitmaps.

FIG. 5B illustrates a block diagram of randomly selected and placed bitmaps.

FIG. 5C illustrates a block diagram of randomly selected and placed bitmaps.

FIG. 5D illustrates a block diagram of randomly selected and placed bitmaps.

FIG. 5E illustrates a block diagram of an optimally routed valid bitmap and an invalid net.

FIG. 6A illustrates a flow chart for generating small bitmaps that are optimally routed.

FIG. 6B illustrates a flow chart for generating complex, optimally routed training datasets by joining the optimally routed small bitmaps of FIG. 6A.

FIG. 7 illustrates a single routing task with unrouted bitmap and the corresponding single-net routed layout.

FIG. 8A illustrates a block diagram of the architecture of the proposed generator network with block level schematics comprising convolutional, dense, and deconvolutional layers.

FIG. 8B illustrates a table of parameters for each layer of the layout router.

FIG. 9 is a flow chart of the proposed postprocessing method.

FIG. 10A illustrates the cGAN routed net output.

FIG. 10B illustrates a refined solution of the postprocessed net of FIG. 10A.

FIG. 11A illustrates incorrect model outputs.

FIG. 11B illustrates correct model outputs.

FIG. 12A illustrates ML outputs on early stages of model training.

FIG. 12B illustrates ML outputs on early stages of model training.

FIG. 12C illustrates ML outputs of a converged model.

FIG. 12D illustrates ML outputs optimally routed.

FIG. 13 illustrates a table of pathfinding performance comparison between the proposed cGAN pathfinder (with postprocessing) and traditional pathfinders.

FIG. 14A illustrates a graph of runtime as a function of terminal and obstacle count.

FIG. 14B illustrates a graph of runtime as a function of terminal and obstacle count.

FIG. 14C illustrates a graph of throughput as a function of terminal and obstacle count.

FIG. 14D illustrates a graph of throughput as a function of terminal and obstacle count.

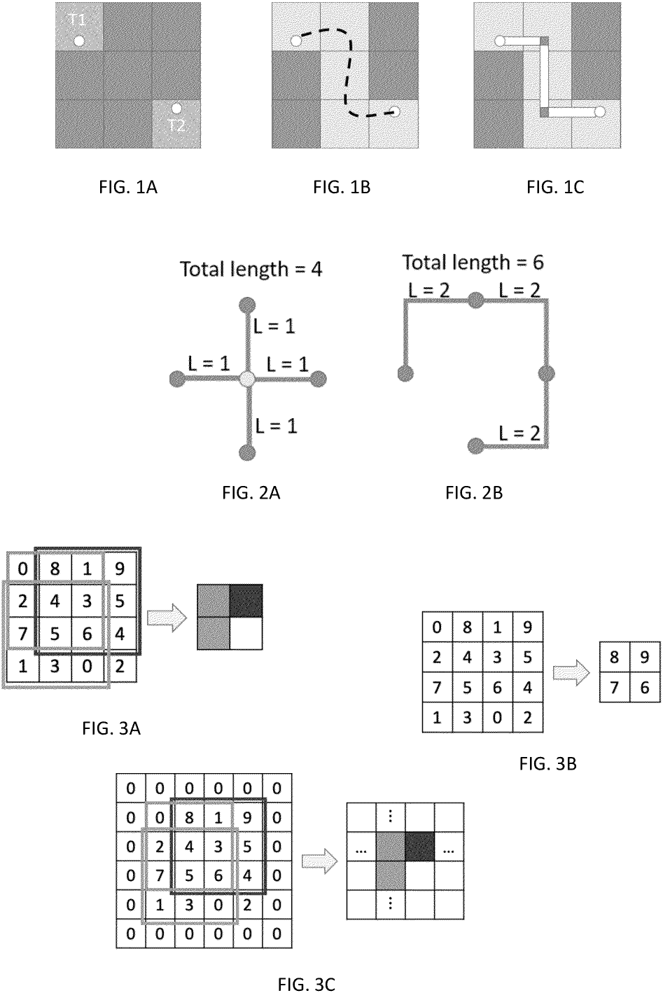

### DETAILED DESCRIPTION

A multiterminal obstacle-avoiding pathfinding system that utilizes deep image learning. In accordance with the principles herein, a conditional generative adversarial network (cGAN) can be trained to interpret a pathfinding task as a graphical bitmap and consequently map a pathfinding problem onto a pathfinding solution represented by another bitmap. The multiterminal obstacle-avoiding pathfinding system can comprise a net generator in a bitmap format comprising a trainable cGAN configured to generate a cGAN routing architecture solution to connect all the terminals and to generate complex, obstacle-avoiding multiterminal net while minimizing wirelength of the routed net. The system can comprise a trainable cGAN operably connected to a processor comprising executable software configured to generate an image-to-image mapping for the cGAN routing architecture solution. The system can further comprise a parallel computing hardware (including but not limited to graphical processing units (GPU), tensor processing units (TPU), neural processing units (NPU)) operably connected to the processor. In addition, the system can further comprise synthetic or commercially available routed training samples for training the cGAN generator, operably connected to the processor of the system.

With ML based net routing, ML models are trained on the existing routed circuits and exploited for routing of unseen nets. Specifically, the traditional routing problem of multiterminal nets in presence of obstacles is mapped onto a modern image manipulation problem and solved with a generative neural network (NN). With the proposed method, the generative NN is trained on a synthetically generated data, that satisfy the properties of optimally routed net. It is shown that a properly designed deep NN, trained on robust reference data can efficiently learn and detect routing patterns in inference and precisely determine the preferred routing heuristic. A multiterminal obstacle-avoiding pathfinding approach inspired by deep image learning is further described in Multiterminal Pathfinding in Practical VLSI Systems with Deep Neural Networks. Utyasmishev, Dmitry & Partin-Vaisband, Inna. 13 Oct. 2022; doi.org/10.1145/3564930, incorporated by reference.

Unlike traditional (sequential by nature and thus, operable by CPUs) routers, modern ML image processing solutions are reduced to convolution operations (e.g., within a convolutional kernel or convolutional layers of deep neural networks), that are decomposed into a large number of small independent matrix multiplications. Parallel processing hardware can, therefore, be efficiently utilized in this type of computation with large number of cores and parallel access to local and shared memory, in accordance with the principles herein. Thus, mapping a pathfinding problem onto a 2D image transforms an inherently sequential problem to a naturally parallelizable one, enabling efficient utilization of parallel computing platforms. Identifying an appropriate class of imaging problems and effectively representing routing problems within that class is, therefore, a primary objective.

In accordance with the principles herein, routing is reconsidered in a new way as a particular case of image-to-image translation. In imaging, the translation is a class of problems which learns the per-pixel mapping from an input bitmap to an output bitmap, hence translating one possible data representation into another. This approach is useful in various domains and applications, such as style transfer, inpainting, and object transfiguration and typically exploited for transforming and repairing photos. Thus, a traditional unrouted IC can be reconsidered as an image with missing routing nets and transformed into a fully reconstructed routed IC with image translation approach. Existing image translation solutions are typically based on generative NNs and thus, highly parallelizable. An exemplary generative NN is set forth herein to demonstrate the proof of the routing image translation capabilities, yielding a fundamentally new, highly scalable and parallelizable solution for the traditional net routing problem.

Multiterminal pathfinding in presence of obstacles is a bottleneck for efficient and fast global routing — a fundamental step in the physical design of modern ICs. During global routing, numerous nets are generated by electronic design automation (EDA) tools, connecting sets of placed IC terminals within the constraints of placed obstacles and the technology node. Global routing is a complex combinatorial problem yet requires both precise and computationally efficient solution. As part of global routing in modern VLSI systems, up to billions of multiterminal nets are connected within a multilayered routing region, partitioned into an array of rectangular tiles. The quality and runtime of global routing solution is, therefore, a strong function of a single net routing (i.e., pathfinding) performance. To mitigate the computational complexity of the single-net routing, existing solvers use approximation heuristics, producing sub-optimal solutions in reasonable time. The traditional deterministic net routing approaches typically exhibit the following design flow: nets are decomposed into multiple terminal-to-terminal routing problems and the terminal-to-terminal problems are solved individually.

Modern pathfinding approaches vary primarily by algorithms for net decomposition and terminal-to-terminal routing as well as algorithm convergence criteria. The primary limitation of these approaches is the unpredictability of routing convergence and performance. Several important machine learning (ML) approaches have recently been proposed to alleviate the unpredictability issue. With these approaches, ML models are utilized to predict congestion and wirelength and propose preferred routing heuristics. Guided by the ML insight, the traditional algorithms used to physically route nets are, however, still rely on grid traversing and yield non regular and, thus, poorly parallelizable computational methods. While neural networks (NNs) typically utilize highly parallelizable topologies (i.e., a single instruction can be simultaneously performed with multiple data points on multiple processing units), existing routers are series in their nature and their runtime cannot be efficiently shortened through parallelization (i.e., instructions are highly inter-dependent and should be executed in order). Such routing with poorly scalable traditional methods becomes even more challenging with the increasing number of terminals and obstacles in modern ICs.

In accordance with the principles herein, unseen nets are routed with similar wirelength and within a fraction of time as compared with state-of-the-art. With the proposed approach, nets are accurately routed within a fraction of time required with traditional routers. The routing problem is reduced to the image-to-image manipulation problem. The two-dimensional (2D) grid structure of the wire routing problem is exploited to map the multiterminal net inputs and outputs onto the 2D bitmaps. Routing information is accumulated over various layouts and generations of integrated systems, continuously increasing routing performance in new layouts with similar cells. This approach is in particular significant in typical global routing use cases, in which thousands of nets are routed within the same placement configuration of standard cells. A synthetic robust dataset of optimally routed nets is efficiently generated, thus overcoming a major concern of limited existing EDA data.

The routing process for systematic execution on GPU hardware is parallelized. While routing parallelization is limited with traditional approaches, the parallel nature of GPU systems allows seamless and efficient processing of a high number of routing problems in a simultaneous manner and with no overhead. As a result, the exemplary method herein opens new directions for parallelization of multiterminal pathfinding and scaling of the computer-aided global routing.

Generative machine learning can include an ML trained using a set of computational techniques that can be exploited for searching complex patterns in large volume of data and predicting the output based on provided input and ML parameters. Supervised learning is one type of ML paradigm that utilizes training data for determining ML model parameters. Each training sample can comprise an input and the corresponding true label. During the training, the ML model can be iteratively updated to minimize the error between its output and the true label.

Variational autoencoders (VAEs) have been demonstrated a solution for image-to-image processing problems, such as image colorization, stylization, or inpainting. A VAE is a DNN that combines a recognition and a generative models. The recognition model (commonly designed as a convolutional neural network (ConvNet)) encodes DNN input into a vector of latent state probabilistic distributions of learned attributes, while the generative model (commonly designed as a deconvolutional neural network (DeconvNet)) decodes the randomly sampled latent state distributions into the DNN output.

Convolutional neural networks have been proven as a preferred ML architecture for efficient detection of complex local patterns in 2D maps. A ConvNet is a stack of convolutional and pooling layers. Each convolutional layer is defined by a convolutional kernel that slides over the inputs of the layer, generating a local map based on the local layer features.

Two important hyperparameters of a convolutional layer are stride and padding. While stride controls the sliding of the kernel over the input volume, padding maintains the dimensionality of the data. The objective of a pooling layer is to reduce the dimensionality of data, abstracting the information about complex features as this information propagates forward through a ConvNet. The inner (i.e., with the lowest dimension) latent space represents attributes of a given input as a probability distribution. When decoding from the latent space, latent attributes are sampled from corresponding distributions to generate a vector that is further processed with deconvolutional layers. The concepts of kernel size, stride, padding, and pooling are exemplified based on a 4x4 bitmap with a 3x3 kernel, stride of one, and pooling that prioritizes maximum values, as shown in FIG. 3. Specifically, ConvNet hyperparameters are shown on a 4x4 bitmap with a 3x3 kernel. In FIG. 3A a convolutional 3x3 kernel with a stride of one reduces the bitmap dimension from 4x4 to 2x2. In FIG. 3B, dimensionality is reduced with max-pooling, and FIG. 3C shows that bitmap dimension is maintained from FIG. 3A to FIG. 3B with intermediate zero padding.

Deconvolutional neural networks are commonly used to decode a low dimensional data space into a dimensionally higher space. The DeconvNet topology is similar to ConvNet, except for the up-sampling DeconvNet layers that replace the pooling ConvNet layers.

Conditional generative adversarial networks (cGANs) are an advanced ML training approach. With this approach, generator (VAE is commonly used as a cGAN generator) and discriminator submodels are utilized and conditioned by a certain input (e.g., a generated net is conditioned by certain placed terminals and obstacles). A discriminator convolutional model is trained to classify an output bitmaps as a true label or ML generated bitmap. Simultaneously, the generator is trained to produce output bitmaps that cannot be recognized by the discriminator as ML generated. As a result, the error between the generated and expected (i.e., true label) output bitmaps are reduced over successive training iterations. The adversarial nature of the architecture allows the generator submodel to simultaneously learn the mapping between 1) the input (e.g., unrouted IC) and generated output (e.g., the corresponding routed IC) bitmaps, and 2) the true label (e.g., a state-of-the- art like routed IC) and generated output. A cGAN can generate routed paths based on previously unseen inputs and thus, can be trained to route unseen ICs.

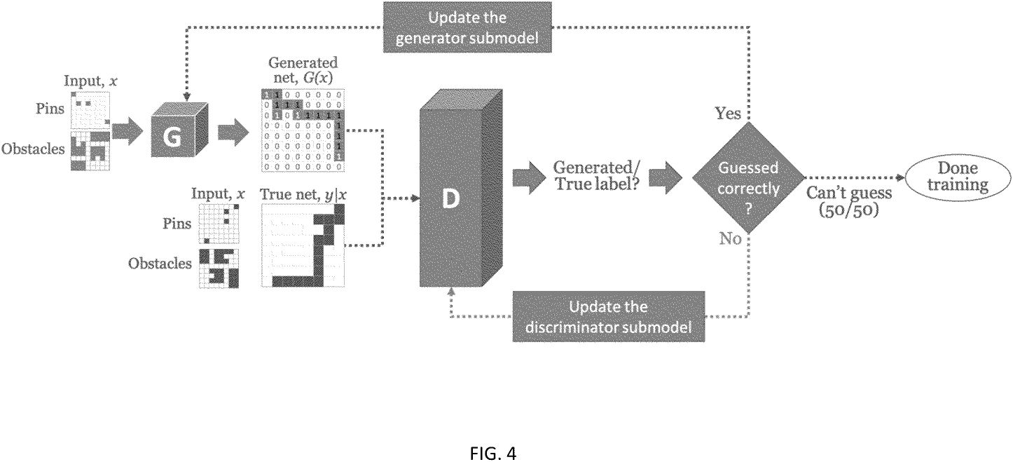

As opposed to conventional dictionary-based approaches and lookup tables, a cGAN is not limited to reproducing known outputs by key, but can generate routed nets from previously unseen inputs. The training process of cGAN ML model is illustrated in FIG. 4.

As shown in FIG. 4, a cGAN routing architecture solution is generated by executing iteratively the cGAN with inputs from a training dataset to generate a trained model. At each iteration, a variational autoencoder (VAE) generator predicts a routing path for a set of terminals based on a VAE model, and a convolutional discriminator distinguishes between a “true” path from a training dataset and a predicted path from the VAE generator based on a generator model. Either the VAE model is updated if the convolutional discriminator performed the distinguishing step correctly or the generator model is updated if the convolutional discriminator performed the distinguishing step incorrectly. Training is complete when the convolutional discriminator cannot any longer perform the distinguishing step to perform a guess. A final VAE model is defined as the cGAN routing architecture solution.

Performance of ML system is a strong function of a training set and training time. Model convergence time increases with the increasing number of training data samples. Alternatively, as the number of training samples is reduced, or the diversity of training data becomes limited, the risk of model overfitting is increased, yielding high performance with a training set but low performance with unseen input data. Typical imaging training sets comprise up to a few thousands data samples. In the next section, the formulation of a multiterminal routing as an imaging problem is proposed and ML system design considerations are described. Design solutions that facilitate generation of a robust training set and convergence of the model in reasonable time without overfitting.

The proposed workflow of ML-based router comprises three key phases. An exemplary training set of 2D bitmaps (i.e., routed and unrouted bitmap pairs) is generated during the first phase . During the second phase, a cGAN model is trained on the training set with physics aware loss function. While the generation of training set and the training are time consuming tasks (e.g., can take hundreds of hours on NVIDIA GTX1080 platform), these tasks are not necessarily performed from scratch. Existing training sets from other very large scale integrated (VLSI) systems and technology nodes can be reused and enhanced. Furthermore, design of an updated training set and model training can start as early as a new technology node is released and fine-tuned later for a specific VLSI system. Finally, transfer learning and learning with partial layout information (e.g., information about certain standard cells) can be utilized to fine-tune pre-trained models, enhancing the overall routing performance. The process of training set generation and training itself is, therefore, expected to improve over generations of VLSI systems. During the third (inference) phase, routing inputs are parsed and marked in corresponding layers of the 2D ML input array and mapped into a routing solution with a properly trained generative ML model. A typical concern with the proposed approach is the connectivity of a generated net. While in imaging problems, a missing or incorrect pixel has little effect on the overall performance, a routing net with a missing pixel exhibits an open circuit and thus invalid solution. To maintain net connectivity, those nets that are generated with disconnected clusters (based on experimental results, less than ten) are post-processed. Each of the framework phases is explained in detail in the following subsections.

The methodology to efficiently generate a robust high-resolution training set is now described. To approach a pathfinding challenge as a supervised ML task, the ML model needs to be trained on a set of pathfinding reference samples (i.e., bitmaps with terminals, obstacles, and corresponding paths). A deep learning model requires a significant amount of training samples. Effective and fast generation of pathfinding tasks and the corresponding, state-of-the-art like output path solutions is, therefore, a primary concern. While a straightforward generation of random pathfinding tasks is feasible, generating tens of thousands of complex path samples required to train a cGAN model with one specific resolution has not been practical with existing tools.

Although any dataset may be used to train the cGAN system, an exemplary dataset generation methodology is now discussed. This methodology is directed to synthetically generating a dataset and is further described in U.S. Non-provisional Application No. 18/065,053 filed Dec. 13, 2022 and incorporated herein in the entirety.

The key idea for the synthetic dataset is merging several low-resolution reference samples into more complex samples. A large set of pathfinding tasks is generated within small rectangular bitmaps with each small bitmap comprising at least one terminal or a path segment placed on the bitmap perimeter (i.e., edge terminal or edge path segment). These small bitmaps are optimally solved with exhaustive pathfinding methods and a valid merge of solved paths into a longer, more complex path within a larger bitmap is accomplished by joining two bitmaps via two edge segments. Smaller bitmaps can be rotated and flipped as needed. The merging process continues until the resulted bitmap reaches the target sample size.

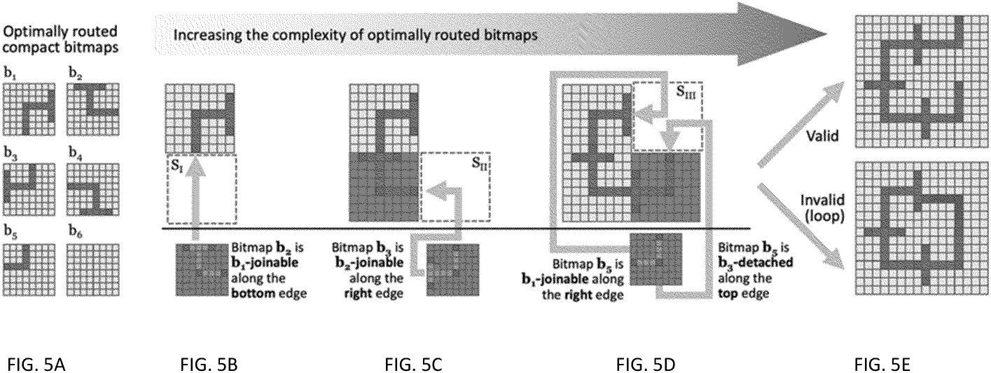

FIG. 5 illustrates the proposed flow for generating a training sample of optimally routed high-resolution net. In FIG. 5A, a set of low-resolution optimally routed bitmaps are shown. In FIG. 5B, bitmap bl is randomly selected and placed. Given the single bitmap, b1, adjacent to the unprocessed space SI, the bitmap, b2, is randomly selected from the list of bl-joinable bitmaps and placed in SI along the bottom edge of bl. In FIG. 5C, the single bitmap, b2, adjacent to the unprocessed space SII, the bitmap, b3, is randomly selected from the list of b2-joinable bitmaps and placed in SII along the right edge of b2. In FIG. 5D, given the two bitmaps, bl and b3, adjacent to the unprocessed space SIII, the bitmap, b5, is randomly selected from the intersection of the bl-joinable and b3-detached bitmaps and placed in SIII along the right edge of bl and top edge of b3. As a result, an optimally routed valid bitmap with 4x resolution is generated as shown in the top of FIG. 5E. Alternatively, selecting the last bitmap from the intersection of the bl - and b3-joinable bitmaps results in an invalid circular net as shown in the bottom of FIG. 5E. Thus, bitmaps are always selected from the intersection of a joinable and detached lists.

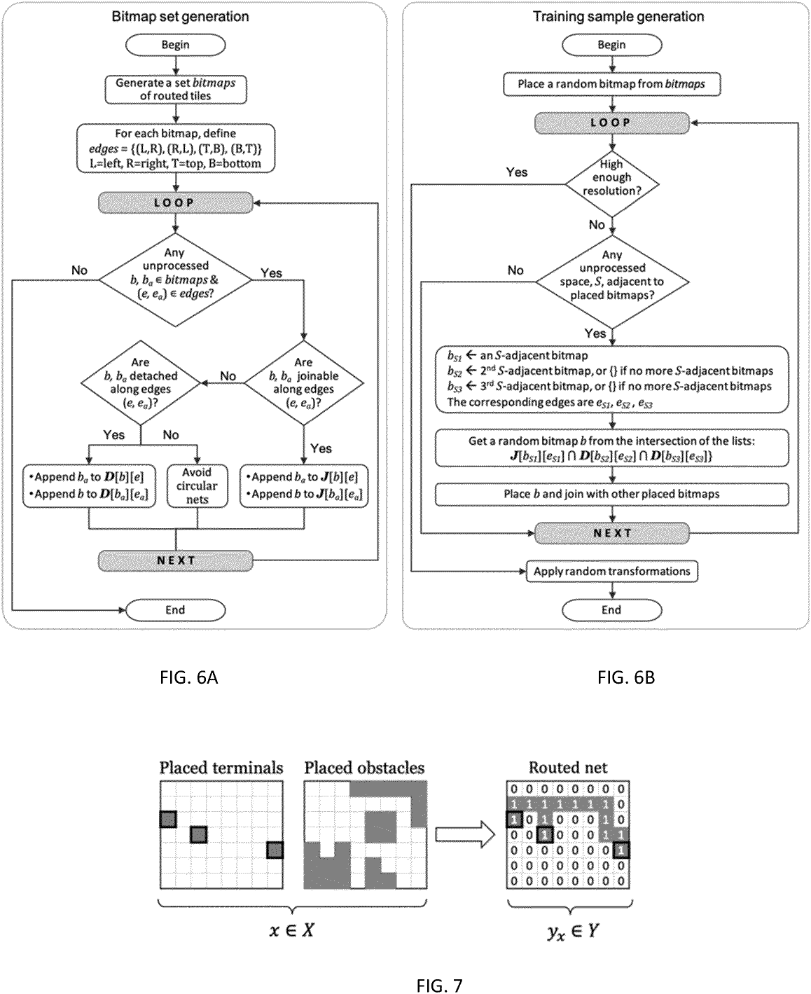

The flow diagram of the training set generation is shown in FIG. 6. FIG. 6A illustrates the flow for generating small bitmaps. These bitmaps are optimally routed with optimal algorithm shown in FIG. 6B. Specifically, FIG. 6B illustrates the flow for generating complex, optimally routed training dataset by joining the optimally routed small bitmaps.

At each iteration, a bitmap is randomly selected from a pool of bitmaps and matched with another random bitmap from the pool for a valid merging. It should be noted that bitmaps generated in this manner tend to exhibit statistically significant difference in path density at the edge tiles, increasing the risk of model overfitting during training. To mitigate overfitting, each path resulted from a valid merging is shifted in a random direction, as shown in FIG. 5. Input data comprises a 2 × N × M array, where N, M < 1024. The bounding box of each input sample is randomly shifted within the 1024 x 1024 processing space and the remaining space is marked as an obstacle. The grouped and shifted bitmap is added to the pool and the process continues to the next iteration. A model trained on the resulted training set is expected to capture broad pathfinding rules in presence of obstacles. To capture a system specific obstacle constraints, another fine-tuned data set is generated. Samples in this set are generated in the following manner. Tiles from a typical layout are randomly sampled and combined into a small bitmap (e.g., 128x128). The bitmap is utilized to generate thousands of pathfinding tasks with numerous randomly placed terminals, which are routed with conventional methods. Based on experimental results (see documents incorporated by reference), including the fine-tuned data within the training set significantly increases the saturation speed of the trained model. The proposed method yields high-quality training data, as has been demonstrated based on the cGAN ability to converge to an effective pathfinding model. Again, this dataset generation methodology is merely exemplary as it is contemplated that any dataset may be used to train the cGAN system.

The architecture of the cGAN router and the proposed physics aware loss function are now explained. For a neural network architecture, the typical conditional adversarial loss is defined as

$$\begin{matrix}{L}_{c G A N} = {x , y}_{} \left[log D \left(y \left|x\right)\right)\right] + \\ {x , z}_{} \left[log \left(1 - D \left(G \left(x , z\right) \left|x\right)\right)\right)\right] ,\end{matrix}$$

where × is the input bitmap, y is the expected (routed) output bitmap (i.e., the true label), z is the random noise, generator G : x, z -7 y aims at minimizing the loss, and the adversarial discriminator D : x, y ➔ {‘true’, ‘generated’) aims to maximize the loss. While in traditional cGANs, random noise is utilized to generate different, stochastic outputs, in a typical router, the preferred output is not random but determined based on physical IC characteristics. In accordance with the principles herein, the cGAN is designed without the random noise but enhanced with physics-aware net generation reconstruction loss function, Lr. The trained generator G* is, therefore, determined by

$${G}^{*} = arg {min}_{G} {max}_{D} {L}_{c G A N} \left(G , D\right) + λ {L}_{r} \left(G\right) .$$

To understand how the Lr(G) is determined, consider the following definitions for formulating the net routing problem as a supervised ML task. Let X and Y be the sets of, respectively, unrouted bitmaps with placed terminals and obstacles and corresponding single-net routed layouts. A routing task is to find the preferred routing path of tiles, yₓ G Y, connecting a certain number of placed terminals under certain obstacle constraints, as defined by x E X. For an unrouted nxn bitmap × E X, the corresponding single-net routed layout yₓ G Y is an n × n bitmap of tiles (i,j); 1 < i, j ≤ n, where each tile is associated with a binary score, y(i, j) = 0 or y(i, j) = 1 if the routing tile (i, j) is, respectively, excluded from or included within the preferred net routing path. These definitions are illustrated in FIG. 7. Note that the overall objective is to maximize the total number of routed paths, while minimizing the total wirelength of the routing solution. In the ML domain, the goal is to train a ML system Y = If (X, G*) + 0.5J that for each x ∈ X provides the conditional probability of each tile, y̅ₓ̅(i,j), to be either included within (i.e., f (i, j) >_ 0.5) or excluded from (i.e., f (i, j) < 0.5) the preferred global routing solution,

$${f}_{\left(i , j\right)} \left(X , {G}^{*}\right) = {P}_{{G}^{*}} \left({\hat{y}}_{x \left(i , j\right)} = 1 \left|x\right)\right) ,$$

where G* is the generator model trained based on the conditional probability distribution of the input features, xᵢ, and output observations, yᵢ (i.e., true labels), as defined by Equation (2). The training data set

$${\left\{\left({x}_{k} , {y}_{k}\right)\right\}}_{k = 1}^{N}$$

comprises N synthetic routing tasks in the bitmap representation and N corresponding reference single-net routed layouts (i.e., the true labels).

Mean square error (MSE) loss function is typically used with autoencoders for evaluating sum of squared distances between the predicted values and true labels. For the net routing problem, MSE counts the number of tiles that marked differently (‘0’ vs ‘1’) with the true label and generated solution. Note that for an n × n optimally routed layout, the number of empty (ƒ(i,j) < 0.5) and routed (f (i, j) >_ 0.5) tiles scales as, respectively, O(n2) and 0(n) with n). This unbalanced nature of the routing data set fosters prioritization of the “all zeros” solution (i.e., an empty layout), which validity further increases with the increasing bitmap size n. Thus, MSE loss function is impractical for ML routing (pathfinding).

Specifically, an input 2D image with input terminals and obstacles is encoded as a 2D array, wherein a value of each cell corresponds to its content: ‘t’ for a terminal, ‘o’ for an obstacle, and 0 for an empty cell. The encoded 2D array is used as a single input to the cGAN. An output array is generated by the cGAN with portions that match the input encoded 2D array, wherein values of one or more cells are modified from 0 to 1 making the one or more cells part of a predicted routing path.

To account for specifics of net routing problems, a custom loss function is proposed. The custom loss function is designed to penalize the model if the number of tiles, nₜ, included by the model within a routing path is different from the number of tiles in a reference routing path, nₜ. The penalties for nₜ exceeding and falling short of nₜ differ. A path with redundant tiles is not optimal in terms of the wirelength, but is legal if it connects all the input terminals. Alternatively, if nₜ < nₜ and the reference path is optimal, then some components in the model solution are disconnected and the path is, therefore, incorrect. In particular, the nₜ < nₜ penalization pertain to the “all-zeros” local minimum. Given a predicted layout, y, and a reference layout, y, the proposed loss function accounts for |n̅t < nt| ≠ 0 with penalty rate of ksub-opt and for incomplete routes with additional penalty rate of Kerr, yielding

$${L}_{r} = \text{MSE} \left(\hat{y} , y\right) ⋅ \left(1 + {k}_{\text{sub-opt}} ⋅ \text{step} ⋅ \text{distance}\right) ,$$

where

$$\text{distance =} {\sum }_{i , j} H \left({\hat{y}}_{i , j}\right) - {\sum }_{i , j} H \left({y}_{i , j}\right)$$

$$\text{step =} {k}_{\text{err}} ⋅ \text{sign} \left(\text{distance} - 1\right) + 1.$$

Here H(.) is the Heaviside step function. In accordance with the principles herein, the proposed loss function is used with k_{sub}-ₒₚₜ = 10_{′}³ and kₑᵣᵣ= 10². The proposed generator is designed as a multistage NN. All tiles with the individual obstacle and terminal indicators are fed as ML features into the input channels of the generator. The input dimension of the network is therefore 2n2, as determined by the total number of features of the n × n tile bitmap.

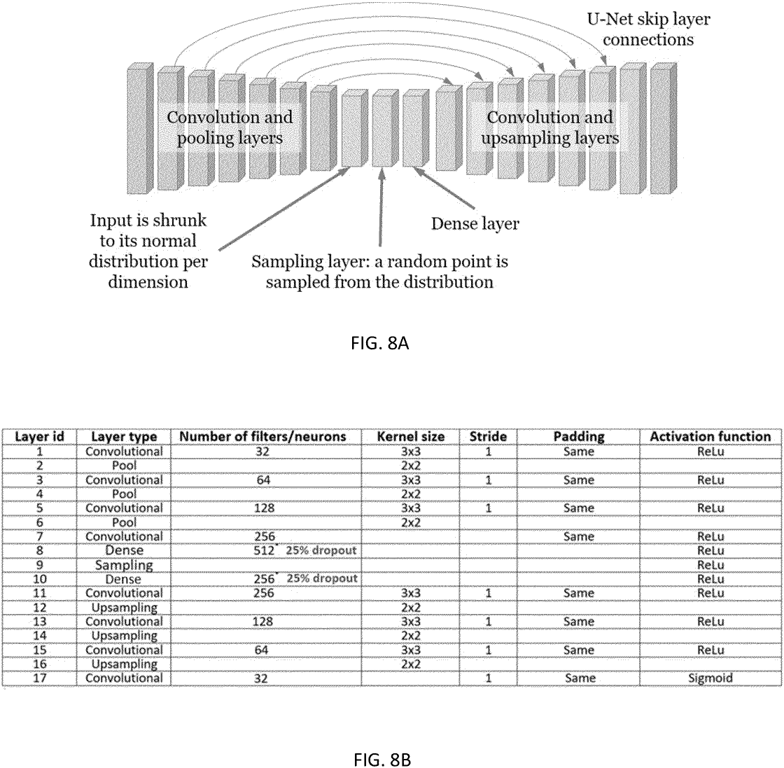

To mitigate the high input dimensionality of the system, a ConvNet based VAE can be used. A typical VAE architecture (see FIG. 8A) is utilized, comprising seven encoding layers, three latent dense layers, seven decoding layers, and a single refining layer. In dense layers, 25% of inputs is dropped out (i.e., set to zero) at each update during the training to prevent overfitting. The encoder converts the 2n²-dimensional input data into an intermediate low-dimensional (i.e., 256x2) data space, using a stack of convolutional layers. The decoder then deconvolves the abstracted data into the n²-dimensional routed output space, using a stack of deconvolutional layers. Each of the output values indicates the probability of the corresponding tile to be included within the routing path. The final decision to include a tile within the global routing path is made based on the decision threshold of 0.5. If a tile output value exceeds this threshold, the tile is considered to be part of the routing path. Unlike other generative models which require more complex training approaches, the proposed NN configuration is a linear stack of layers and naturally supports error backpropagation throughout the overall network. As a result, efficient training of the VAE generator within the intermediate low-dimensional dense layers is possible. Owing to the stochastic nature of the ML model, new (unseen) routing solutions can be generated based on the training data points (i.e., existing or synthetically generated routed layouts) by sampling the intermediate probabilistic space. For optimization reasons, the generator NN is augmented with skip connections between corresponding convolutional and deconvolutional layers, similar to the U-Net NN architecture. FIG. 8B illustrates the NN parameters for each layer of the pathfinder.

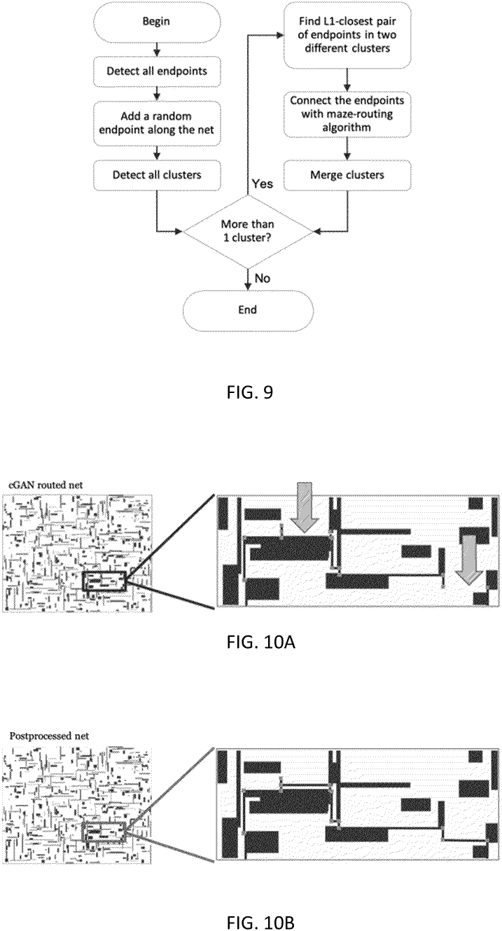

The post-processing algorithm for merging clustered cGAN nets is now presented. While several missing or corrupted pixels typically go unnoticed in ML generated images, missing net pixels yield an invalid routing solution. A postprocessing algorithm is proposed to merge the few disconnected cGAN clusters, as needed. As part of the algorithm, an invalid net is processed with the median filter for image noise reduction and the net clusters are connected with the cluster merging algorithm (see FIG. 9). With the proposed algorithm, pairs of closest endpoints (from two different clusters) are identified for all disconnect endpoints based on Manhattan distance. To merge two clusters, the identified closest endpoints are connected with maze-routing algorithm. While the proposed greedy algorithm is generally suboptimal, it has been shown to exhibit optimal results when used to connect only few clusters in cGAN routed ICs.

An example of the postprocessed output is shown in FIG. 10. In this case, the cGAN routed net exhibits of FIG. 10A includes three disjoint clusters that are joined with the proposed post-processing algorithm shown in FIG. 10B. Note that with a completely random input (i.e., randomly generated number and location of pins and obstacles), most of the unprocessed cGAN routed nets yield between two and ten disjoint clusters.

This routing behavior is primarily caused by overfitting issues and can be solved with either the proposed post-processing or fine tuning of training set. When the cGAN model struggles to converge to a correct output, a grid of dots with tile-like size is produced, as shown in FIG. 11A and FIG. 11B. This is, however, not a fundamental limitation of the methods herein, but a constraint of the utilized synthetic training set. With a more heterogeneous training set that contains larger diversity of routing tile sizes, post-processing may not be required. Such training set generation methods should be considered in the future.

### EVALUATION AND EXPERIMENTAL RESULTS

The proposed cGAN router has been designed for 1024x1024 layouts and tested with the following routing inputs.

1) A set of unseen routing tasks generated synthetically by merging small bitmaps used for generating the fine-tuned training set.

2) A set of pathfinding tasks generated by randomly placing rectangular obstacles and terminals within a bitmap. The number and size of the obstacles as well as the number of terminals are all randomly determined.

3) Net routing benchmarks RT 01-05.

For evaluation purposes, the input data is represented as a 1024x1024x2 array, in which the first and second channel are the per-tile obstacle and terminal indicators, respectively. Bitmaps smaller than 1024x1024 are upsized to 1024x1024 and/or filled with obstacle indicators along the bitmap edge.

With respect to evaluation metrics, the cGAN router is evaluated with respect to four primary metrics: correctness of routing (i.e., a correct net must connect all the terminals in a continuous manner), wirelength (as determined by the number of net tiles), runtime, and throughput. To evaluate the correctness of the ML pathfinding, best-find search is utilized to find all connected tiles within the routed path (i.e., those tiles with f (i, j) >_ 0.5). Each search starts at one of the terminals and progressively constructs a set of visited tiles. At each iteration, the tiles adjacent to the already traversed tiles are added to the set. The search stops when all the tiles have been traversed.

Turning to experimental results, the cGAN router was trained on an exemplary dataset of synthetically generated routing dataset and tested on the RT routing benchmarks and synthetically generated test cases. The tested routing tasks were not part of the training set and were never seen by the cGAN model.

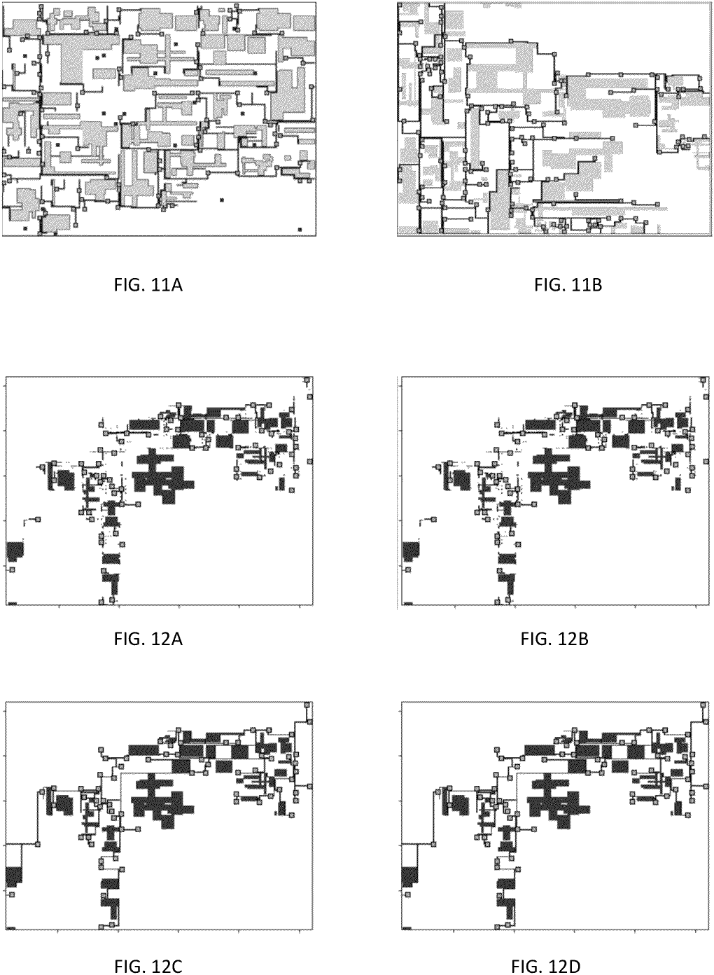

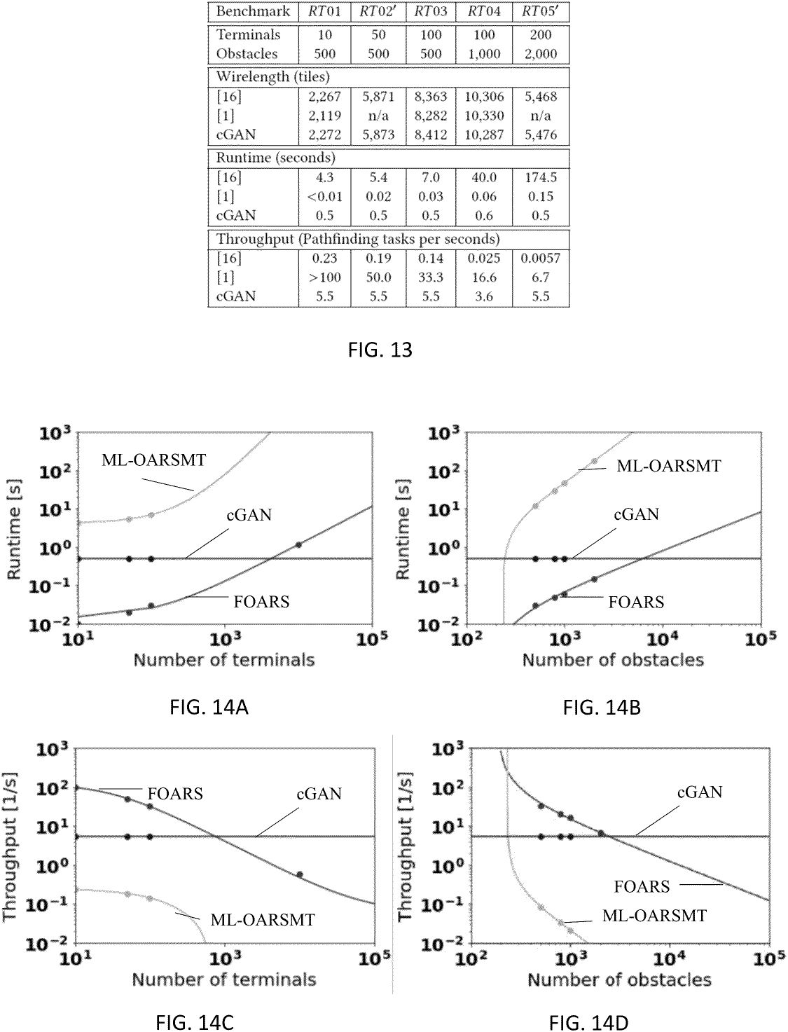

The cGAN pathfinder is able to generate a path with similar to state-of-the-art length for inputs of different complexity. An example of the cGAN pathfinder output at various stages of training is shown in FIG. 12A, FIG. 12B, FIG. 12C, FIG. 12D. Performance comparison between the cGAN and state-of-the-art deterministic pathfinding algorithms (ML-OARSMT and FOARS), is listed in FIG. 13 for the RT benchmarks. The size and complexity of these benchmarks are typical for commercial multiterminal pathfinding cases in applications such as IC design global and detailed routing, where a typical number of net terminals ranges between 10 and 1000.

Both deterministic algorithms are based on the look-up table-accelerated decomposition of multiterminal pathfinding. FOARS provides an enhanced method of obstacle-aware decomposition, yielding state-of-the-art performance. While ML-OARSMT yields less competitive performance, it utilizes an open-source fundamental algorithm (FLUTE) which lies at the core of other state-of-the-art pathfinders and is re-executed for a fare, hardware-specific comparison. Alternatively, FOARS cannot be conveniently re-evaluated.

With the modern hardware accelerators, such as GPU, TPU, or NPU, batching individual ML inference requests can significantly impact ML runtime and throughput performance. While the optimal batching parameters vary for different models, systems, and environments, the throughput-to-latency ratio can usually be efficiently controlled by batching within hardware constraints (e.g., batch data should it into hardware accelerator memory).

In practical applications such as IC design, millions of pathfinding tasks are solved during each pathfinding iteration. Thus, pathfinding throughput (as determined by the number of solved pathfinding tasks per unit of time) is a critical metric and should be considered along with the traditional pathfinding runtime metric. To maximize throughput performance, a batch size of 16 samples is preferred, yielding a 5x higher throughput as compared with non-batched single pathfinding inference. To account for both the parallel hardware accelerator ML processing and sequential CPU postprocessing with the proposed approach, pathfinding throughput is determined as

$$T {P}_{c G A N} = \frac{B a t c h S i z e}{R {T}_{M L} + B a t c h S i z e \times R {T}_{P o s t p r o c e s s}} ,$$

where RT_{ML} is the runtime to route BatchSize paths with ML cGAN model, and RT_{Postprocess} is the postprocessing runtime per a single path. Alternatively, the throughput of the existing CPU based sequential approaches is determined as one over a single pathfinding runtime.

Note, that the proposed formulation of pathfinding as image translation enables parallelization of pathfinding with non-branching computations, propagating the input through the directed acyclic graph of cGAN generator submodel layers. Thus, the runtime of the cGAN pathfinder is not a function of the number and configuration of terminals and obstacles. Intuitively, ML processing runtime is constant and defined by the ML model, underlying framework implementation, and hardware. Based on the experimental results, the ML processing runtime of the trained ML model executed on NVIDIA GTX1080 GPU is ≈ 0.4 seconds. Note that the postprocessing runtime varies between 0.1 and 0.2 seconds for all the tested data and is a function of the ML model prediction quality. Thus, the postprocessing runtime can be reduced with additional training. Alternatively, the runtime with traditional approaches increases quadratically with the increasing number of obstacles and terminals.

The constant runtime of the ML model is experimentally verified on a synthetic test set of 60 1,024 × 1,024 unseen pathfinding tasks generated based on the proposed methodology. The length of the synthetically generated paths is considered as the reference length in these experiments. The number of terminals among the test set paths ranges between 10 and 1,063. The total area occupied by obstacles ranges between 6.7% and 35.8%. All the 60 test samples are routed with the cGAN pathfinder. The wirelength with cGAN is similar to the reference length and the runtime for all the paths varies between 0.4 + 0.1 = 0.5 and 0.4 + 0.2 = 0.6 seconds.

The cGAN pathfinder is further evaluated with standard RT benchmarks. The experimental results are listed in FIG. 13. As expected, the speedup with cGAN pathfinder over sequential state-of-the-art continuously increases with the increasing number of terminals and obstacles. Similarly, the throughput gain with cGAN also increases in more complex pathfinding problems. The projection of these trends is shown in FIG. 14A, FIG. 14B, FIG. 14C, FIG. 14D based on extrapolated results from FIG. 13.

The data is extrapolated as follows: (i) The reported worst-case complexity of traditional pathfinding algorithms is O(n2), where n is the number of terminals or obstacle corners of the input, (ii) The throughput of these algorithms is approximated as a reciprocal function of runtime. The cGAN pathfinder outperforms the FOARS algorithm in terms of runtime and throughput (for ;::; n > 10³-10⁴ - a realistic number of terminals and obstacles in modern and future pathfinding tasks). The cGAN pathfinder outperforms the ML-OARSMT algorithm by over an order of magnitude even in small pathfinding systems. As compared with the proposed method, the traditional pathfinders are less practical in tasks with high number of terminals and obstacles.

FIG. 14A and FIG. 14B illustrate graphs of runtime as a function of terminal and obstacle count. FIG. 14C and FIG. 14D illustrate graphs of throughput as a function of terminal and obstacle count.

This shows that a multiterminal obstacle avoiding pathfinding can be efficiently solved with a generative cGAN model executed on effective hardware accelerators, such as GPU, TPU, or NPU hardware. Based on the experimental results, the proposed cGAN model correctly determines paths in unseen benchmarks, yielding a state-of-the-art like path length and in those larger systems over an order of magnitude speedup and throughput gain.

The proposed approach exploits the grid-like structure, that is most common in routing and navigation systems, to map the input pathfinding tasks and output paths to two-dimensional bitmaps and reduce the multiterminal obstacle-avoiding pathfinding to an image-to-image mapping. The proposed framework is enhanced with field-aware information and methodology for designing robust routed training dataset. Executing the pathfinding on parallel hardware accelerators allows to simultaneously and efficiently process high number of pathfinding tasks without additional overheads. The proposed cGAN pathfinding architecture and the methodology for designing synthetically obtained training samples enables a fundamentally novel approach for obstacle-avoiding multiterminal pathfinding in modern computing systems. This approach is expected to overcome some of the existing CPU bottlenecks by utilizing GPU or other parallel processing hardware. In particular, cGAN pathfinder is effective in industrial IC physical design tasks such as global routing and placement, as well as in autonomous vehicle navigation and planning.

While the disclosure is susceptible to various modifications and alternative forms, specific exemplary embodiments have been shown by way of example in the drawings and have been described in detail. It should be understood, however, that there is no intent to limit the disclosure to the embodiments disclosed, but on the contrary, the intention is to cover all modifications, equivalents, and alternatives falling within the scope of the disclosure as defined by the appended claims.

1. A multiterminal obstacle-avoiding pathfinding system comprising:
a bitmap generator comprising a trainable conditional generative adversarial network (cGAN) configured to generate a cGAN routing architecture solution to connect all the terminals and to generate complex, obstacle-avoiding multiterminal net while minimizing wirelength of the routed net.

2. The multiterminal obstacle-avoiding pathfinding system of claim 1, wherein the cGAN routing architecture solution is generated according to the steps of:
executing iteratively the cGAN with inputs from a training dataset to generate a trained model, wherein in each iteration the steps are:
predicting by a variational autoencoder (VAE) generator a routing path for a set of terminals based on a VAE model, and
distinguishing by a convolutional discriminator between a “true” path from a training dataset and a predicted path from the VAE generator based on a generator model,
updating either the VAE model if the convolutional discriminator performed the distinguishing step correctly or the generator model if the convolutional discriminator performed the distinguishing step incorrectly,
stopping the executing step when the convolutional discriminator cannot any longer perform the distinguishing step, and
defining a final VAE model as the cGAN routing architecture solution.

3. The multiterminal obstacle-avoiding pathfinding system of claim 1, the trainable cGAN operably connected to a processor comprising executable software configured to generate an image-to-image mapping for the cGAN routing architecture solution.

4. The multiterminal obstacle-avoiding pathfinding system of claim 3, wherein the image-to-image mapping is generated according to the steps of:
encoding as a 2D array an input 2D image with input terminals and obstacles, wherein a value of each cell corresponds to its content: ‘t’ for a terminal, ‘o’ for an obstacle, and 0 for an empty cell;
using the encoded 2D array as a single input to the cGAN,
generating by the cGAN an output array with portions that match the input encoded 2D array, wherein values of one or more cells are modified from 0 to 1 making the one or more cells part of a predicted routing path.

5. The multiterminal obstacle-avoiding pathfinding system of claim 4, wherein the output array is an output image that comprises the predicted routing path and the input terminals and obstacles.

6. The multiterminal obstacle-avoiding pathfinding system of claim 1, further comprising a post-processing component configured to merge clustered nets generated by the cGAN.

7. The multiterminal obstacle-avoiding pathfinding system of claim 3, further comprising a parallel processing hardware (such as GPU, TPU, NPU, or similar) operably connected to the processor.

8. The multiterminal obstacle-avoiding pathfinding routing system of claim 7, further comprising synthetic or commercially available routed training samples for training the cGAN generator, operably connected to the processor of the system.

9. A multiterminal obstacle-avoiding pathfinding system comprising:
a trainable conditional generative adversarial network (cGAN) operably connected to a processor, the cGAN trained to interpret a pathfinding task as a graphical bitmap and to map a pathfinding problem onto a pathfinding solution represented by another bitmap of the system.

10. The multiterminal pathfinding system of claim 9, further comprising a dynamic, synthetically generated or commercially available dataset (example in application) operably connected to the processor.

11. The multiterminal pathfinding system of claim 10, configured to enable effective parallelization on parallel processing (such as GPU, TPU, NPU or similar) hardware, wherein the system yields over an order of magnitude speedup over traditional approaches with no wirelength overhead.

12. The global pathfinding system of claims 9, further comprising a post-processing component configured to merge clustered nets generated by cGAN.

13. The system of claim 12, wherein the post-processing component is further defined by a median filter for image noise reduction of an invalid net, and a cluster merging instruction set connecting the net clusters, the median filter and cluster merging instruction set operably connected to the system via the processor.

14. The system of claim 13, the cluster merging instruction set configured to identify pairs of closest endpoints from two different clusters for all disconnect endpoints based on Manhattan distance, and to merge two clusters, the identified closest terminal endpoints are connected with a maze-routing instruction set.

15. The system of claim 14, further comprising one or more components to connect all the terminals in the multiterminal pathfinding solution.

16. The system of claim 15, further comprising at least two deep neural networks.

17. The system of claim 9, further comprising a submodel generator conditioned by an input comprising placed terminals and obstacles.

18. A multiterminal obstacle-avoiding pathfinding system comprising:
a custom loss function having instructions configured to penalize a routing model if a number of tiles, nₜ, included by the model within a routing path is different from a number of tiles in a reference routing path, n_{t,ref}, wherein penalties for nₜ exceeding and falling short of n_{t,ref} differ.
